(19) United States
(12) Patent Application Publication
(10) Pub. No.: US 2016/0214878 A1
(43) Pub. Date: Jul. 28, 2016

(54) TREATMENT OF PRODUCED WATER FOR SUPERCRITICAL DENSE PHASE FLUID GENERATION AND INJECTION INTO GEOLOGICAL FORMATIONS FOR THE PURPOSE OF HYDROCARBON PRODUCTION

(71) Applicant: GENERAL ELECTRIC COMPANY, Schenectady, NY (US)

(72) Inventors: Lanny Dale WEIMER, Ellicott City, MD (US); Christian Ulrich HAUSSMANN, Seattle, WA (US); John Archer SEGERSTROM, San Ramon, CA (US)

(73) Assignee: GENERAL ELECTRIC COMPANY, Schenectady, NY (US)

(21) Appl. No.: 15/021,428

(22) PCT Filed: Sep. 12, 2014
(86) PCT No.: PCT/US2014/055422

§ 371 Date: Mar. 11, 2016

Related U.S. Application Data
(60) Provisional application No. 61/877,629, filed on Sep. 13, 2013.

(51) Int. Cl. C02F 9/00; C02F 1/66; C02F 1/20; C02F 1/42; C09K 8/592; E21B 43/24

(52) U.S. Cl. CPC C02F 9/00; C09K 8/592; E21B 43/24; C02F 1/20; C02F 1/42; C02F 1/66; C02F 2101/101

(57) ABSTRACT

Water, for example produced water, is treated to make it more suitable for use in an oil field recovery process. In the oil filed recovery process, the treated water is pressurized and heated to supercritical conditions in a steam generator, preferably a Once Through Steam Generator (OTSG), to result in a supercritical dense phase fluid, which is then injected into oil bearing formaltions for the purpose of enhanced oil production. The treatment includes softening and decarbonation. The water is preferably acidified before decarbonation. There may be a step of sulfate removal. Softening may be by ion exchange or membrane separation. Sulfate may be removed by ion exchange.

### CROSS-REFERENCES TO RELATED APPLICATIONS

This application is a national stage application under 35 U.S.C. §371(c) of prior filed, co-pending PCT application serial number PCT/US2014/055422, filed on Sep. 12, 2014, which claims priority to U.S. provisional patent application No. 61/877,629, titled “Injection of Supercritical Steam into Oil Bearing Geological Formations for the Purpose of Oil Production”, filed Sep. 13, 2013. The above-listed applications are herein incorporated by reference.

### BACKGROUND

This specification relates to treatment of produced water, for example for re-use in making a supercritical dense phase fluid useful in oil production.

The following paragraphs are not an admission that anything discussed below is common general knowledge or otherwise citable as prior art.

The currently used technology for Enhanced Oil Recovery (EOR) is the injection of subcritical saturated steam into heavy oil bearing geological formations, where the steam is generated in either a Once-Through-Steam Generator (OTSG) or a drum boiler. Saturated steam is also used in Steam Assisted Gravity Drainage (SAGD) processes for recovering oil from oil sands, and in other oil production techniques. These methods are particularly useful for producing heavy hydrocarbons such as heavy petroleum crude oil and oils sands bitumen.

Produced water refers to the water phase of a produced oil/water mixture that is pumped out of a geological formation, for example after steam vapor has heated the formation by heat transfer and steam condensation. Once recovered, the produced water is separated from the oil and then treated optionally for subsequent reuse. In particular, the produced water may be re-used to create more steam for oil production.

The produced water treatment required for re-use in a conventional OTSG operation typically includes processes such as de-oiling, filtration, and ion exchange or chemical softening, as required to make sure the produced water does not scale or foul the OTSG heater tubes. The pretreatment for the drum boiler option may include some of the same processes as are used for the OTSG, such as deoiling and softening. To make the water suitable for feeding to a drum boiler, however, the water is additionally polished to meet drum boiler specifications. Additionally or alternatively, de-oiled produced water may be treated in an evaporator where almost all of the salts and organic components are removed to result in a pure distillate.

When OTSGs are used for EOR, the saturated steam is typically about 80% quality to maintain heat flux rates in the tubes, meaning that typically only the 80% steam quality vapor phase is generated and injected into the formation.

In the methods described above, the OTSG's and boilers are operated at high pressure but at saturated sub-critical conditions. The critical point of water, at which distinct water and gas phases cease to exist, is at about 22.12 MPa (3,206 psi) and 374.15° C. (705° F.). Above this critical point, there is a supercritical dense phase fluid. Although this fluid is neither water nor vapor, it is sometimes referred to as supercritical water or supercritical steam.

The use of a supercritical dense phase fluid for oil production is described in US Patent Application Publication Number US2014224491 (A1), “System And Process For Recovering Hydrocarbons Using A Supercritical Fluid”, published on Aug. 14, 2014. A system described in this publication has a source for providing a first aqueous liquid, a heater for heating the first aqueous liquid to a temperature from 374° C. to 1000° C. at a pressure from 3205 to 10000 psia such that the first aqueous fluid is in a supercritical phase, a delivery system to receive the first aqueous fluid from the heater for injection into an underground hydrocarbon reservoir in the supercritical phase, and a well configured to recover from the reservoir hydrocarbons that have been heated by the first aqueous fluid. A corresponding process is also described. The first aqueous fluid may be flashed across a venturi choke as it is injected through the wall of a wellbore. The flashed steam may be at least 70% quality steam. The source for providing the first aqueous fluid may be drinking water, treated wastewater, untreated wastewater, river water, lake water, seawater or produced water. The second aqueous fluid in the supercritical phase may be used for upgrading recovered hydrocarbons.

### SUMMARY OF THE INVENTION

The following summary is intended to introduce the reader to the detailed description to follow and not to limit or define any claimed invention.

Supercritical dense phase fluid has not yet been used in any commercial oil recovery operation. Instead, supercritical dense phase fluid generators are currently used mainly in the electric power generating industry. In particular, supercritical dense phase fluid is used to drive high efficiency steam turbines. Water fed to such supercritical dense phase fluid generator—turbine combinations is typically highly purified, with essentially all organic and inorganic components removed before entering the supercritical dense phase fluid generator. The water treatment processes used are typically rigorous and costly. This expense is justified in the power industry, however, because supercritical dense phase fluid is more efficient in a Rankine cycle wherein mechanical power is generated by expanding steam.

Efficiency in generating power by expansion is not as critical to the use of steam in oil production. Efficiency in oil production is determined instead primarily by the total system efficiency in transferring heat to the geological formation. This total system efficiency includes losses in efficiency resulting from treating feed water, heat flux limits, steam distribution and steam quality control. Unlike the power industry, it is not practical to remove nearly all contaminants to very low levels in water to be used for oil recovery. However, there are currently no guidelines describing how and to what extent water, particularly produced water, should be treated for use in making supercritical fluid for oil recovery.

This patent describes systems and methods of water treatment. The water being treated more particularly includes produced water. One use of these systems and methods is to produce, or help produce, treated water may be used in an oil production system or method in which supercritical dense phase liquid is injected into an oil bearing formation. Although the mechanical power of steam expansion is not very important in oil production, supercritical dense phase liquid has a greater energy content per unit mass than subcritical saturated steam. The steam distribution and injection network in an oil field frequently involves long, complicated and large piping systems as well as steam quality control devices. With supercritical dense phase fluid, by contrast, distribution pipes can have a smaller diameter and, therefore, can be less costly to purchase and install compared to saturated steam piping. Furthermore, steam quality control devices can be eliminated. In an embodiment, at least some of the water fed to the supercritical dense phase fluid generator is treated produced water. The steam generator is may be an OTSG.

The inventors believe that the stringent feed water requirements specified by the power industry are a result of the steam generator-turbine combination and would not be appropriate for oil recovery processes. The pure water requirements of the power industry are dictated in part because the dense phase fluid generator feeds a high speed power generating turbine where the highest steam purity is essential. The supercritical dense phase fluid described in this patent has no such turbine related purity requirements since it is injected into a subterranean geological formation. Instead, supercritical dense phase fluid can be made from produced water in an OTSG after only limited preconditioning. Systems and methods described in this patent include relatively simple treatment steps. These systems and methods are biased towards removing those contaminants that would be most troublesome for the OTSG. Other contaminants are not removed, or may even increase in concentration.

In a process described in this specification, produced water is softened and decarbonated. In an embodiment, the decarbonation is provided by an acidification step followed by a degassing step. The process may also include a step of sulfate removal, particularly if sulfate is added in the acidification step. Alternatively or additionally, the process may involve membrane separation to remove divalent ions.

A system described in this specification has a membrane separation unit or a combination of a softening unit and a decarbonating unit. In one example, a system has an ion exchange unit with hardness selective resin and a decarbonation unit. The decarbonation unit may have an acidification unit upstream of a degassing unit. There may also be a second ion exchange unit with sulfate selective resin.

### BRIEF DESCRIPTION OF THE FIGURES

FIG. 1 shows a schematic process flow diagram for a system that can be used for creating supercritical dense phase fluid for oil production, including pretreatment of water using softening, decarbonation and, optionally, selective ion exchange for the removal of sulfates or other undesirable components.

FIG. 2 shows a schematic process flow diagram for a system that can be used for creating supercritical dense phase fluid for oil production, including pretreatment of water using conventional or high temperature reverse osmosis processing, optionally in additional to other pretreatment processes.

### DETAILED DESCRIPTION

Hydrocarbons may be recovered from an underground formation, alternatively called a reservoir, with the assistance of water pressurized and heated to supercritical conditions in a steam generator to produce a dense phase supercritical fluid. Although supercritical dense phase fluid is not steam, the words “steam generator” are still commonly used since the equipment required is similar to a conventional steam, generator. The supercritical dense phase fluid is more particularly produced in a Once-Through Steam Generator (OTSG). Optionally, make-up water may also be added to the steam generator. The supercritical dense phase fluid is injected into the oil bearing reservoir or formation to enhance hydrocarbon production in a manner similar to SAGD, EOR or other processes using sub-critical steam.

Supercritical water conditions typically include a temperature from 374° C. (the critical temperature of water) to 1000° C., may be from 374° C. to 600° C. and more particularly from 374° C. to 455° C., and a pressure from 22 MPa (the critical pressure of water) to 70 MPa, may be from 22 MPa psia to 50 MPa and more particularly from 22 to 30 MPa.

The hydrocarbons may be heavy oil or bitumen. The word “oil” will be used in this specification to include heavy oil, bitumen and other hydrocarbons that may be recovered using injected steam or supercritical fluid.

A delivery system for the supercritical fluid can be made up of high pressure piping. Due to the very high energy content of supercritical fluid, the piping may have a small diameter, for example about 61 cm or less. There is generally no need for equal phase splitting to maintain steam quality as in sub-critical delivery systems. The reservoir feed stream may be injected via a choking device such as a venturi choke. A stream of hydrocarbons mixed with water is recovered from the reservoir, for example using a submersible pump or high pressure pump that discharges into a producer wellbore or oil gathering pipeline. Optionally, the supercritical fluid delivery system may split the supercritical fluid into two streams. In this case, one stream is injected into the reservoir and the other stream is mixed into the producer wellbore or oil gathering pipeline to reduce the viscosity of recovered hydrocarbons or otherwise upgrade them.

In an embodiment, it is preferable to inject the supercritical dense phase fluid directly into the oil-bearing formation, or to at least delay expansion until the supercritical dense phase fluid has travelled part way to its point of injection, since this allows for a smaller injection piping system to be used and for the uniform distribution of latent heat. When using supercritical dense phase fluid in place of the subcritical saturated steam, the density is high enough that the dense phase fluid can be generated at 100% quality and distributed to the formation at superheated conditions without heat flux issues.

US Patent Application Publication Number US2014224491 (A1), “System And Process For Recovering Hydrocarbons Using A Supercritical Fluid”, published on Aug. 14, 2014 describes examples of supercritical steam enhanced oil recovery and is incorporated herein by reference.

In order to reduce one or more potential processing problems within the steam generator or distribution piping or both, the water is treated before it enters the steam generator. Potential problems include plugging, scaling, fouling, corrosion and erosion among others. The treatment allows produced water to be reused to generate supercritical fluid. Plugging from salt deposits is a particular problem when using produced water.

The treatment may include one or more of the following: softening (particularly comprising removal of calcium, magnesium or both), acidification, decarbonation (particularly comprising removal of one or more of total inorganic carbon, carbonate and bicarbonate, more particularly including removal of carbonate), selective ion exchange to remove sulfates or other non-hardness components, and membrane separation of divalent ions. The removal of a component, for example calcium, magnesium, carbonate, bicarbonate or sulfate, is typically achieved through the removal of ions of that component but the component may alternatively be removed as part of a salt. Membrane separation may use conventional or high temperature membranes in the reverse osmosis or nanofiltration range. Two examples of treatment systems will be described below but the selection of treatment processes and their sequential order in the treatment train may vary with the produced water chemistry and characteristics, as well as with the specific oil production facility arrangements and requirements.

When produced water reaches supercritical conditions, most of its organic components will decompose to form lower molecular weight compounds. The inorganic compounds present in the produced water will precipitate as salts so that only a small concentration of ions, for example about 100 to 400 parts per million (ppm), will remain in solution in the supercritical dense phase fluid. The precipitated salts may be either Type 1 or Type 2 salts. Type 1 salts are generally non-sticky or non-scaling precipitates that may exist in a salt rich aqueous phase mixed with the supercritical fluid. Type 1 salts typically re-dissolve once the supercritical fluid returns to sub-critical conditions. Type 2 salts form sticky precipitates that are more likely to adhere to, and form scale on, surrounding surfaces including heat transfer surfaces of the steam generator. Type 1 salts may optionally be allowed to flow through the steam generator and even to the oil bearing formation. In contrast, Type 2 salt forming components are removed from the produced water upstream of the steam generator. The word “removed” in this specification does not require the complete removal of a component but also includes a reduction in the concentration of that component, to a degree effective to materially reduce the rate of Type 2 salt formation in the supercritical dense phase fluid.

Type 1 salts include NaCl, KCl and K₂CO₃. Type 2 salts include Na₂CO₃, Na₂CO₃, Na₂SO₄, Na₃PO₄, K₂SO₄ and SiO₂. However, these characterizations are generally determined in single species solutions. When there are mixtures of salts, more complex reactions occur at or near supercritical conditions. For example, Na₃PO₄ and K₂SO₄ are both type 2 salts but in a mixture at or near supercritical conditions they may form K₃PO₄ and Na₂SO₄ which are a Type 1 and Types 2 salt respectively.

The produced water treatment steps may condition the water so that the majority of the precipitate in the OTSG will be in the form of Type 1 salt(s). The Type 1 salts can remain entrained within the OTSG and distribution piping, or optionally may be removed by use of a suitable separation system.

After exiting the steam generator the supercritical dense phase fluid will be fed to the oil field injection point or points via a piping distribution network. The supercritical dense phase fluid may be reduced to subcritical temperature and/or pressure within the piping distribution network or may be let down to subcritical conditions at the point of injection, for example via a venturi let-down device, thereby entering the oil bearing formation or formations as saturated, subcritical steam.

The produced water is treated to reduce the level of one or more selected constituents that may be detrimental for the OTSG operation as the water is pressurized and heated to supercritical conditions within the OTSG's tubes. The removal or partial removal of certain of the water's chemical components reduces the rate of deposit buildup or other harmful events taking place within the OTSG or distribution piping.

More particularly, the produced water is de-oiled. Since many organics will decompose to lower molecular weight compounds at supercritical conditions, organic contaminants may be minimally treated if at all. Similarly, inorganic compounds likely to form Type 1 (generally non-scaling) salts may be minimally treated if at all. Type 2 salt forming constituents are removed from the produced water, for example by softening and/or decarbonation and/or selective ion exchange and/or membrane separation procedures.

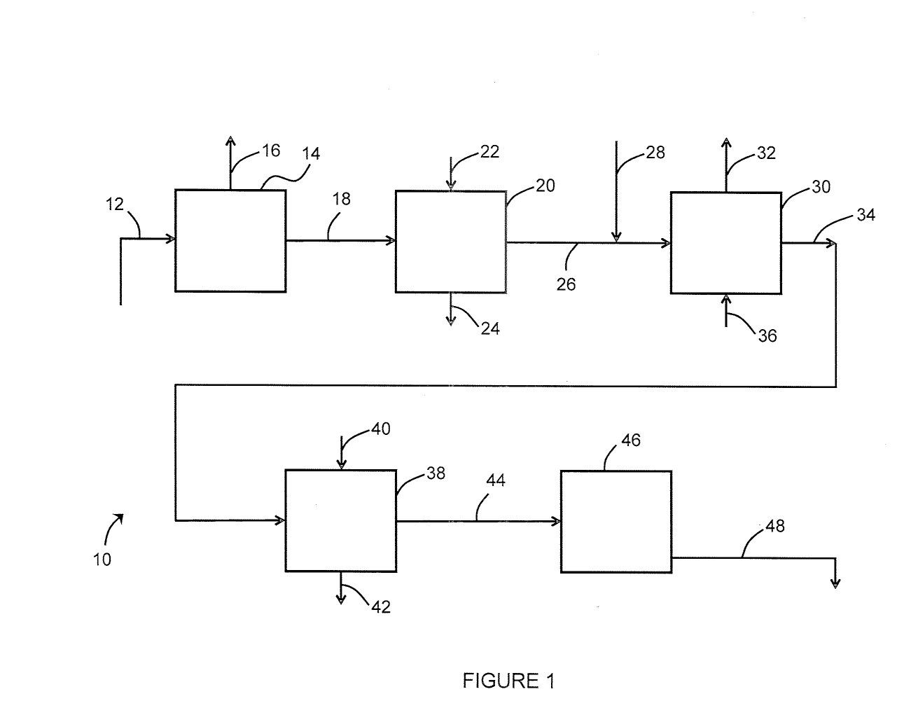

FIG. 1 shows a treatment system 10 for producing supercritical dense phase fluid from produced water. Produced water 12 from oil production is first de-oiled in an oil—water separation and filtration system 14. The oil—water separation and filtration system 14 can include conventional de-oiling unit processes typically including an oil-water gravity separator and one or more of the following: dissolved air or gas floatation, induced gas floatation, chemical additives, coalescers and media filtration such as walnut shell filtration. Recovered oil 16 is removed from the process.

De-oiled water 18 is softened in a softening system 20. The softening system 20 my use, for example, chemical precipitation as in warm lime softening or an ion exchange (IX) process. Reagents 22 such as NaCl brine, HCl, Caustic or other chemicals are added to the softening system to precipitate hardness or regenerate ion exchange resins. Spent regenerant or chemical sludge 24 is removed from the system 10. The softening system 20 reduces the hardness in the produced water creating softened water 26.

The softened water 26 is then decarbonated in a degassing unit 30, for example a stripping column or vacuum degasification unit. In an embodiment, an acid 28 such as hydrochloric acid (HCl) or sulfuric acid (H2SO₄) is added to the softened water 26 upstream of the degassing unit 30. A striping gas 36, for example air or steam, may be added to the degassing unit 30. Stripped gasses 32, particularly carbon dioxide (CO₂), are removed from the degassing unit 30. A decarbonated water 34 is produced which has a reduced concentration of total inorganic carbon (in particular carbonate and/or bicarbonate), may be a reduced concentration of carbonate.

The acid 28 reduces the pH of the produced water to increase the degree of decarbonation. Acidification for the purpose of decarbonating may be achieved by using any acid 28, but is typically carried out using hydrochloric acid, phosphoric acid, nitric acid or sulfuric acid. If an acid is used that will contribute to Type 1 salt formation, like hydrochloric, phosphoric or nitric acid, then the water will be ready to enter the OTSG. If an acid is used that will contribute to Type 2 salt formation, like sulfuric acid, then additional pretreatment steps ahead of the OTSG may be required to remove sulfate (SO₄) and/or other Type 2 salt forming components.

As an example, the system 10 of FIG. 1 includes an optional sulfate removal unit 38. In this example, sulfate removal is by way of selective ion exchange. Regenerant 40 is added when required and spent regenerant 42 is sent to disposal or for further treatment. Decarbonated water 34 enters the sulfate removal unit 38 is converted to treated water 44 with a reduced sulfate content.

If necessary, silica or silicates can also be removed from the produced water. This can be done, for example, by chemical precipitation or other means. However, in at least some produced waters the silica/silicate concentration is already low enough to create supercritical dense phase fluid without treatment.

The treated water 44 enters a supercritical dense phase fluid generator 46. The generator 46 is similar to an OTSG but configured and operated to produce supercritical dense phase fluid 48. The supercritical dense phase fluid 48 is injected into an oil-bearing formation.

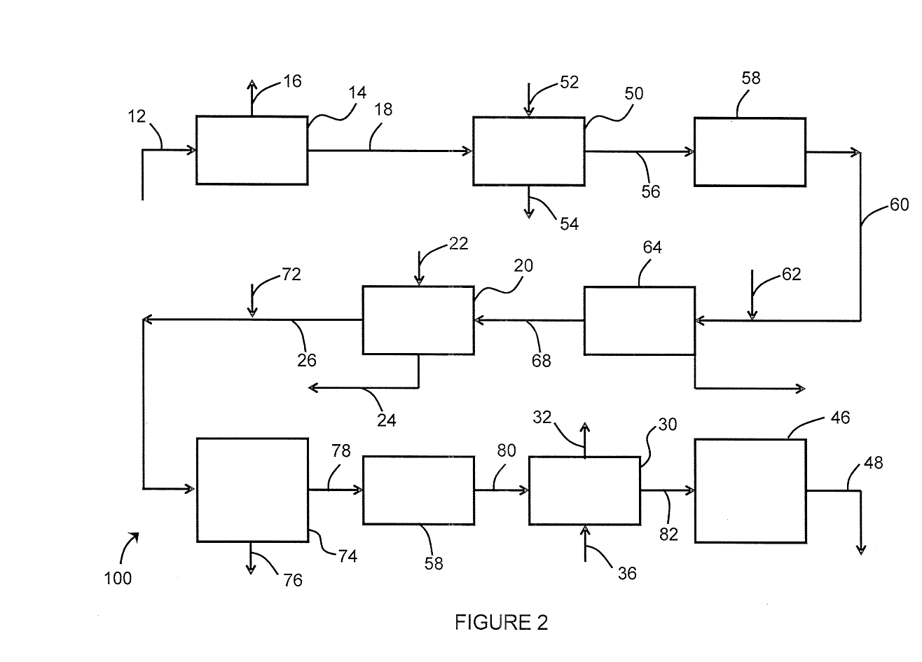

FIG. 2 shows a second treatment system 100 for producing supercritical dense phase fluid from produced water. In this alternative system, the produced water stream is partially desalinated using a reverse osmosis or nanofiltration membrane process. Optionally, a membrane process may also be integrated into the treatment system 100 of FIG. 1. In FIG. 2, treatment units previously described in relation to FIG. 1 are given the same reference numerals.

Referring to FIG. 2, a membrane treatment unit 74 may include reverse osmosis or nanofiltration membrane modules. The modules may be operated at conventional temperatures below 45° C. Alternatively, there may be high temperature modules capable of processing water at temperatures above 45° C., referred to as high temperature reverse osmosis membranes (HTRO) treatment. High temperature reverse osmosis and nanofiltration membranes are described, for example, in U.S. patent application Ser. No. 13/045,058, Spiral Wound Membrane Element and Treatment of SAGD Produced Water or Other High Temperature Alkaline Fluids, filed by Goebel at. al. on Mar. 10, 2011. This application is incorporated herein by reference.

For both conventional and high temperature membrane processing, pretreatment of the membrane feedwater is typically required to remove free and dissolved oils as well as other fouling or scaling organic and inorganic components from the produced water. In FIG. 2, de-oiled water is treated in a polishing unit 50, a heat exchanger 58, a filter 64 and a softening system 20.

The polishing unit 50 removes additional oil and organic contaminants. Chemicals or reagents 52 are added to the produced water as needed to produce a removed contaminants stream 54. The contaminants stream 54 contains oils and other organics and may optionally be recycled the oil—water separation and filtration system 14 for further treatment. The heat exchanger 58 is used, if necessary, to reduce the temperature of the produced water for downstream membrane units. The filter 64 may be, for example, a microfiltration or ultrafiltration membrane unit. Removal of solids in the filter 64 may be enhanced with additives 62 if necessary. Filtrate 66 may optionally be recycled the oil—water separation and filtration system 14 for further treatment. Filtered water 68 is further treated in softening system 20. Softened water 26 is ready for treatment by the membrane treatment unit 74. Optionally, reagents 72 may be added before the membrane treatment 74. For example, caustic may be added to avoid silica scaling in the membrane treatment unit 74.

Membrane treatment, whether conventional or high temperature, may use membranes selective to divalent ions, which tend to form Type 2 salts. Alternatively, a membrane process may remove most of the Type 2 forming salt components, and also greatly reduce the Type 1 forming components as well. This will reduce not only the scaling potential in the OTSG but will also greatly diminish the crystalline Type 1 salt formation at supercritical conditions within the OTSG. A reduced salt and organic content in the desalinated produced water feed may improve operation of the OTSG in some cases. In particular, the total dissolved solids (TDS) of water fed to the supercritical OTSG is less than about 14,000 mg/L. In some cases, the produced water may be below this threshold before treatment or after softening and decarbonation. However, if not, then use of membrane separation to increase removal of Type 1 salt constituents is desirable. Membrane reject 76 is disposed of or treated further.

Depending on the molecular weight, molecular shape, electric charge and other characteristics of the organics present in the produced water, the amount of organics removed by the reverse osmosis membrane may vary from a little to most of the organics present in the reverse osmosis feed stream. Although three produced water samples tested by the inventors did not require any organics removal, it is possible that another produced water might benefit from some organics removal. For example, some organics may create an acid or gas in the OTSG or distribution systems, which may be harmful to the metallurgy of these systems.

Reverse osmosis membrane treatment may also reduce or eliminate the need for some of the other pretreatment steps described above, for example hardness and/or sulfate (SO₄) removal using the ion exchange processes previously described.

The membrane unit 74 produces permeate 78. Optionally, a second heat exchanger 58 may be used to warm the produced water if it had been previously cooled to facilitate membrane treatment. Heated produced water 80 is treated in a de-gassing unit 30 as described previously. Optionally, the produced water may be acidified to increase carbonate removal in the de-gassing unit 30. The de-gassing unit 30 may also remove dissolved oxygen form the produced water and other strippable gasses besides carbon dioxide. Treated produced water 82 is then ready to be converted in OTSG 46 into supercritical dense phase fluid 48 for injection into the oil bearing formation.

In an embodiment, the treatment systems 10, 100 described above include a softening step. Most produced waters contain hardness, made up of mainly calcium and magnesium, in sufficient levels to result in potential scaling or other problems in the OTSG. At supercritical conditions, the hardness components result in Type 2 forming salts and may be removed prior to entering the OTSG. Hardness removal may be achieved by chemical softening, typically carried out in conventional cold, warm or hot lime softeners (chemical removal) and/or in hardness removing ion exchange (IX) systems. Selection of chemical and/or ion exchange processes may be subject to the chemical composition of the produced water and to economic considerations.

Produced waters may or may not also contain some levels of sulfates, which form Type 2 salts at supercritical conditions. Sulfates are, therefore, removed prior to entering the OTSG only if necessary. Low levels of sulfates, possibly up to 10 or 20 mg/L, may be tolerated within the OTSG without detriment or formation of significant levels of Type 2 salts.

One method for removing sulfates is by use of a selective ion exchange system that contains ion exchange resin that preferentially targets sulfates. Treatment using selective ion exchange for the removal of sulfates is shown in FIG. 1. Another method for the removal of sulfates is by use of partial desalination by membrane separation. While these methods of sulfate reduction are preferred, sulfate reduction treatment is not limited to these two options.

Most produced waters contain relatively high levels of alkalinity or hardness (carbon dioxide, bicarbonate and carbonate) which can form Type 2 salts at supercritical conditions. One process of removing alkalinity or hardness from the produced water includes lowering the water's pH (acidification) followed by degassing to achieve decarbonation. Some acids, like sulfuric acid, can result in Type 2 salt formation in the OTSG at supercritical conditions. If non-Type 2 salt forming acids, like hydrochloric, nitric or phosphoric acid are used, the produced water can be fed directly to the OTSG after the alkalinity is removed in the decarbonation process if natural sulfate levels are acceptable. If sulfuric acid is used, there will be a Type 2 salt forming sulfate residual, and an SO₄ removal step may be added. This results in a process having steps of acidification, degassing (decarbonation) and sulfate removal as shown in FIG. 1.

Reverse osmosis or nanofiltration treatment, either conventional or high temperature, may be used to partially desalinate the produced water as the primary pretreatment process or as a supplement to another pretreatment process. As the produced water passes through the reverse osmosis or nanofiltration membranes the stream is split into a mostly desalinated (permeate) and a concentrated (reject) stream. Depending on the type of membrane elements (modules) selected, the permeate stream will contain only a fraction of the inorganic components of the produced water feed stream. While organic components are typically also removed, their degree of removal is dependent on the organic type(s) contained in the produced water.

Due to the oil contaminated nature of produced water, the reverse osmosis or nanofiltration system feed must typically be pretreated to remove membrane fouling components. Such pretreatment may consist of a number of processes, including micro- or ultrafiltration, oil absorption, softening or other. The reverse osmosis pretreatment requirement may vary with produced water characteristics. Reverse osmosis pretreatment may also include the addition of caustic to raise the pH, thus minimizing the danger of membrane scaling by silica.

The partially desalinated and purified permeate stream is passed on to the OTSG for subsequent pressurization and heating to supercritical conditions in the same manner as previously described for the other pretreatment options. The reject stream, containing all the produced water components rejected by the membrane barrier, is either recycled for other uses or disposed of. Treating the produced water by reverse osmosis or nanofiltration may take the place of one or one or more of the following: softening, decarbonation and/or selective ion exchange.

Depending on the produced water temperature and the membrane and possible membrane pretreatment temperature limitations, the produced water may have to be cooled to meet the respective component operating temperature capabilities. An exemplary arrangement of the integrated reverse osmosis treatment process for produced water is illustrated in FIG. 2. Other treatment step sequences are also possible.

The treatment step sequence of applying the above described processes may vary, depending on the produced water composition as well as oil production facility preferences and economic considerations. While the previous discussion lists the typical order of the various process steps, subject to the composition of the produced water and the type of acid used for decarbonation, the actual process sequence listed above and described in FIGS. 1 and 2 may either be not critical or may require a different sequence to improve or make the pretreatment more beneficial and/or economical.

Once the pretreatment in the form of oil removal, and/or softening, and/or specific (i.e. sulfate) ion removal, and/or acidification, and/or decarbonation and/or partial desalination using reverse osmosis or nanofiltration membrane is accomplished, the so conditioned produced water may optionally be deaerated (degasified), or further de-gasified if decarbonated by de-gasification already, ahead of or as part of the OTSG system. In the OTSG, the produced water is raised to its supercritical pressure before it enters the section or sections where it is preheated, typically in a preheater section, and then raised to supercritical temperatures, typically in a radiant section of the OTSG and the super heater section, while being maintained at a supercritical pressure. As the water reaches supercritical conditions, i.e. supercritical temperature at supercritical pressure, most of the salts will begin to precipitate and most of the organic constituents in the water will decompose to lower molecular weight compounds. The precipitated salt(s) and separated organics may be maintained within the tubes and carried through the remaining OTSG sections to the oilfield injection piping. Alternately, the precipitated salts and separated organics may be partially or totally removed or reduced in concentration either in an in-situ or ex-situ device before the supercritical dense phase fluid is further heated in a downstream section of the OTSG or before it enters the oilfield distribution and/or injection piping.

The steam generator may be in the form of an OTSG rather than a drum boiler. The makeup water purity requirements for an OTSG are typically lower than those for a drum boiler. The treatment of the produced water going to a supercritical OTSG consists of only partial treatment and conditioning, rather than the maximum treatment as would be required for a drum boiler and steam turbine, operating at supercritical conditions. Pretreatment in the methods and systems described above are mainly in the form of softening, decarbonating (acidification-degassing), and optionally selective sulfate ion removal, or alternatively desalination using reverse osmosis membrane treatment. All of these treatments target and remove only the troublesome components likely to be present in produced water and to form Type 2 salts. Since some or a majority of organic and inorganic components remain in the water, the pretreatment effort is significantly less stringent as that required for conventional supercritical dense phase fluid for electric power generation.

The treatment of de-oiled produced water may consist essentially of softening, decarbonating (acidification-degassing), and optionally selective sulfate ion removal if a sulfuric acid is used for decarbonating. For example, 80% or more, or 90% or more, or all of the total dissolved solids (TDS) removed from the de-oiled produced water before it enters the OTSG may be provided by these treatment steps.

All of the processes described above for the produced water treatment are relatively simple and inexpensive in comparison to those required for conventional supercritical dense phase fluid for electric power generation. Because of the relative simplicity in the water treatment, the capital and operating costs for chemicals, energy and waste disposal are also less compared to those of conventional pretreatment to generate supercritical dense phase fluid for electric power generation. Adding reverse osmosis or nanofiltration pretreatment creates another waste stream, but this may be partially off-set by the possible elimination or reduction of the other cited pretreatment operations such as softening and/or sulfate removal via ion exchange. Reverse osmosis or nanofiltration treatment would still produce less waste than the treatment necessary to produce high purity water as the type needed for supercritical dense phase fluid for electric power generation.

### EXAMPLES

Produced waters from three different EOR production sites, each varying in salt and organics content, with the salt content ranging from 600 mg/l to 14,500 mg/l total dissolved solids (TDS), were tested untreated in an “as is” (“as sampled and shipped”) and in a pretreated condition. The pretreatment processes consisted of softening, acidification, decarbonation and, in one case, targeted ion exchange for sulfate removal generally according to FIG. 1.

These pretreated waters were then each subjected to supercritical conditions by pressurization to 25 MPa (250 bar 3,626 psi) and heated to and held at discrete supercritical temperatures ranging from 400 to 530° C. (752 to 986° F.) with the most common temperatures for all the testing at 400 and 440° C.

The produced waters were tested at each of these temperatures increments for about two hours to equilibrate and to determine if they formed sticky or scaling salts and to determine whether they caused plugging in an experimental supercritical dense fluid generator.

It was found that each of the untreated produced waters formed sticky and scaling Type 2 salts, consisting of mainly carbonates (including bicarbonate) and sulfates, and caused plugging in the generator. Conversely, the pretreated produced waters primarily Type 1 salts and did not form blockages and scaling in the generator. Rapid plugging of the generator is indicated by a “failed” rating in the results column of FIG. 1 whereas acceptable performance is indicated by a “pass” rating. These test results indicated that all three of the produced water samples had been treated such that it would be possible to use the treated water to create supercritical fluid for oil recovery.

In the tests, both sulfuric acid (H₂SO₄) and hydrochloric acid (HCl) were successfully used for acidifying the water to enable decarbonating. H₂SO₄ is plentiful at oil production sites but increases sulfate concentration in the water. A sample acidified with sulfuric acid was subjected to SO₄ removal using selective ion exchange. In contrast, a sample with high initial TDS was acidified with HCl and not H₂SO₄ so that this sample would not need SO₄ removal. Previous testing had shown that selective ion exchange process to remove SO₄ do not work well with high TDS water.

A list of concentration of various components in the produce water before and after treatment is provided below in Table 1. In Table 1, TIC indicates total inorganic carbon. This value is used to determine HCO₃ or CO₃ concentration. TIC is expressed as C so that conversion to HCO₃ would be TIC×61/12.

TABLE 1

| | | | | TIC | | | | | | |
|---|---|---|---|---|---|---|---|---|---|---|
| | | | | mg/L | | | | | Total | |
| | | TDS | SO₄ | (as | HCO₃ | SiO₂ | Ca | Mg | Sulfur | |
| Sample | Treatment | mg/L | mg/L | C) | mg/L | mg/L | mg/L | mg/L | mg/L | Results |
| 1 | None | 673 | 9.2 | 47 | 241 | 79 | 25 | 4.6 | 3.7 | Failed |
| | Softening, | 728 | 9.7 | 6 | 31 | 80 | 0 | 0 | 3.5 | Passed |
| | acidification | | | | | | | | | |
| | and | | | | | | | | | |
| | decarbonation | | | | | | | | | |
| 2 | None | 3329 | 16 | 198 | — | 49 | 3.6 | 1.8 | 9.7 | Failed |
| | Softening, | n/d | <5 | 0.1 | — | 64 | <1 | <1 | 0.5 | Passed |
| | acidification, | | | | | | | | | |
| | decarbonation | | | | | | | | | |
| | and sulfate | | | | | | | | | |
| | Removal | | | | | | | | | |
| 3 | None | 14838 | 10 | 175 | — | 13 | 29 | 38 | n/d | Failed |
| | Softening, | n/d | 10 | 1.1 | — | 12 | <1 | <1 | n/d | Passed |
| | acidification | | | | | | | | | |
| | and | | | | | | | | | |
| | decarbonation | | | | | | | | | |

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of producing a hydrocarbon comprising the steps of:
treating produced water to reduce the concentration of one or more of: i) hardness, ii) calcium, iii) magnesium, iv) one or more of carbonate, bicarbonate and total inorganic carbon and v) sulfate;
producing a supercritical dense phase fluid from the treated produced water; and,
injecting the supercritical dense phase fluid into a hydrocarbon-bearing geological formation or mixing the supercritical dense phase fluid into a producer wellbore of oil gathering pipeline.

2. The method of claim 1 wherein treating produced water to reduce the concentration of one or more of: i) hardness, ii) calcium, iii) magnesium, iv) one or more of carbonate, bicarbonate and total inorganic carbon and v) sulfate comprises softening and decarbonating produced water.

3. The method of claim 1 wherein the produced water is treated to reduce the concentration of sulfate.

4. The method of claim 1 wherein carbonate is reduced by acidification followed by removal of carbon dioxide gas.

5. The method of claim 1 wherein the treated water is not treated to boiler water quality, for example as described by ASME standards.

6. The method of claim 1 wherein the treated produced water is brought to supercritical pressure and temperature in a Once Through Steam Generator (OTSG).

7. The method of claim 1 further comprising produced water oil separation and/or deoiling prior to treating produced water to reduce the concentration of one or more of: i) hardness, ii) calcium, iii) magnesium, iv) one or more of carbonate, bicarbonate and total inorganic carbon and v) sulfate.

8. The method of claim 1 wherein treating produced water to reduce the concentration of one or more of: i) hardness, ii) calcium, iii) magnesium, iv) one or more of carbonate, bicarbonate and total inorganic carbon and v) sulfate comprises one or more treatment steps selected from the group consisting of i) ion exchange softening and membrane separation.

9. The method of claim 1 comprising a step of ion exchange for sulfate removal.

10. The method of claim 1 wherein Type 1 salts are injected into the formation.

11. A system for the treatment of produced water prior to heating in a supercritical OTSG, the system comprising:
a softening unit;
an acidification unit: and,
a de-gassing unit.

12. The system of claim 11 further wherein a softening unit comprises a membrane separation unit or an ion exchange softening unit.

13. The system of claim 11 further comprising a sulfate selective ion exchange unit.

14. A method of producing a hydrocarbon comprising the steps of:
treating de-oiled produced water by a process consisting essentially of a) softening, b) decarbonation and c) sulfate removal if a sulfate containing acid is used for decarbonation.
producing a supercritical dense phase fluid from the treated produced water; and,
injecting the supercritical dense phase fluid into a hydrocarbon-bearing geological formation or mixing the supercritical dense phase fluid into a producer wellbore of oil gathering pipeline.

15. The method of claim 14 wherein the decarbonation step consists essentially of acidification and degassing steps.

16. The method of claim 2 wherein the produced water is treated to reduce the concentration of sulfate.

17. The method of claim 2 wherein carbonate is reduced by acidification followed by removal of carbon dioxide gas.

18. The method of claim 2 wherein the treated produced water is brought to supercritical pressure and temperature in a Once Through Steam Generator (OTSG).

19. The method of claim 2 further comprising produced water oil separation and/or deoiling prior to treating produced water to reduce the concentration of one or more of: i) hardness, ii) calcium, iii) magnesium, iv) one or more of carbonate, bicarbonate and total inorganic carbon and v) sulfate.

20. The system of claim 12 further comprising a sulfate selective ion exchange unit.
